(19) United States
(12) Patent Application Publication
(10) Pub. No.: US 2010/0075284 A1
(43) Pub. Date: Mar. 25, 2010

(54) Three-Dimensional Perspective Taking Ability Assessment Tool

(76) Inventors: Maria Kozhevnikov, Arlington, VA (US); Michael Kozhevnikov, Newark, NJ (US)

Correspondence Address: GEORGE MASON UNIVERSITY;OFFICE OF TECHNOLOGY TRANSFER, MSN 5G5, 4400 UNIVERSITY DRIVE, FAIRFAX, VA, 22030, US

(21) Appl. No.: 12/428,847

(22) Filed: Apr. 23, 2009

Related U.S. Application Data
(60) Provisional application No. 61/047,306, filed on Apr. 23, 2008.

(51) Int. Cl. G09B 19/00; G06F 3/048

(52) U.S. Cl. 434/258; 715/850

(57) ABSTRACT

The present invention measures one's spatial orientation and spatial navigation abilities by measuring one's perspective taking ability (PTA). PTA can be measured using a 3D PTA assessment tool to apply a test mode in a 3D virtual reality (VR) setting. For each trial in the test mode, the test subject is given a first set of instructions to mentally re-orient himself with respect to an avatar's perspective in the 3D VR setting. A delay condition is added to allow time for mental re-orientation. After the delay ends, the test subject is then given a second set of instructions to point an input device in the direction of a target object. Each response to the second set of instructions is tracked. Furthermore, the response time and accuracy of each response are measured.

### CROSS REFERENCE TO RELATED APPLICATIONS

The present application claims the benefit of provisional patent application Ser. No. 61/047,306 to Kozhevnikov, filed on Apr. 23, 2008, entitled “Three-Dimensional Perspective Taking Ability Tool,” which is hereby incorporated by reference.

### STATEMENT REGARDING FEDERALLY SPONSORED RESEARCH OR DEVELOPMENT

This invention was made with government support under grant ONR_N0001204515 awarded by the Office of Naval Research. The government has certain rights in the invention.

### BACKGROUND OF THE INVENTION

There are two distinct spatial abilities: mental rotation and perspective taking. Mental rotation (also known as allocentric spatial transformation) refers to the ability to imagine the rotation of objects or an array of objects from a fixed perspective. Perspective taking (also known as egocentric spatial transformation) refers to the ability to imagine a reoriented-self (that is, the ability to change one's perspective from another perspective) while still being able to maintain a sense of the overall space. The latter has been shown to be important in wayfinding performance and navigation in space.

Mental rotation of an object or an array of objects involves imagining movement of an object or set of objects relative to an object-based frame of reference, which may specify the location of one object (or its parts) with respect to other objects. In other words, one looks at the way an object moves about an axis or axes intrinsic to the object. As illustrated in FIG. 1, one can picture oneself as the avatar looking at the fire hydrant and determining the position of the bicycle or truck with respect to the fire hydrant.

In such a representation, the location of one object is defined relative to the location of other objects. Existing spatial tests primarily measure mental rotation ability by measuring the ability to imagine rotating objects from a fixed perspective. However, these tests are generally not good predictors of wayfinding performance or navigational skills because they do not require constant updating of self-orientation with respect to other objects.

In contrast, perspective taking involves imagining a different perspective by rotating the egocentric frame of reference. This spatial transformation involves the imagined movement of one's point of view in relation to other object(s). This kind of reference encodes object locations with respect to the front/back, left/right and up/down axes (i.e., x-axis, y-axis, and z-axis) on an observer's body. It is the self-to-object representational system that provides the base for successful navigation of a mobile organism in space. As illustrated in FIG. 2, one can imagine oneself as the avatar looking at the fire hydrant and determining where the bicycle or truck is located with respect to oneself.

A way to measure a person's perspective taking ability (PTA) is applying Dr. Maria

Kozhevnikov's two-dimensional (2D) Perspective Taking Ability test. However, this test is not conducive in providing an overall assessment of the person's spatial adeptness and navigational skills because it is limited to a 2D map format. Although 2D map formatted tests correlate with spatial navigational abilities, they provide limited assessments. Simply, such tests are not a “pure” measure of an egocentric PTA because test subjects can still solve problems using an alternative mental rotation strategy (i.e., mentally rotating vectors instead of imagining oneself being reoriented). Furthermore, because the 2D PTA map format involves additional transformation from the geocentric perspective (i.e., a 2D mindset) to the egocentric perspective (i.e., three-dimensional (3D) mindset), this transformation involves additional non-egocentric processes.

Thus, what is needed is a PTA test (for both assessment and training) that is based on a 3D environment format (i.e., egocentric format). In addition, what is needed is a PTA test that eliminates a test subject's option of solving test problems with a mental rotation or alternative mental rotation strategy. Furthermore, what is needed is a PTA test that can eliminate the transformation of the geocentric perspective to the egocentric perspective.

### BRIEF DESCRIPTION OF THE DRAWING

FIG. 1 shows an example of an avatar viewing objects based on allocentric transformation.

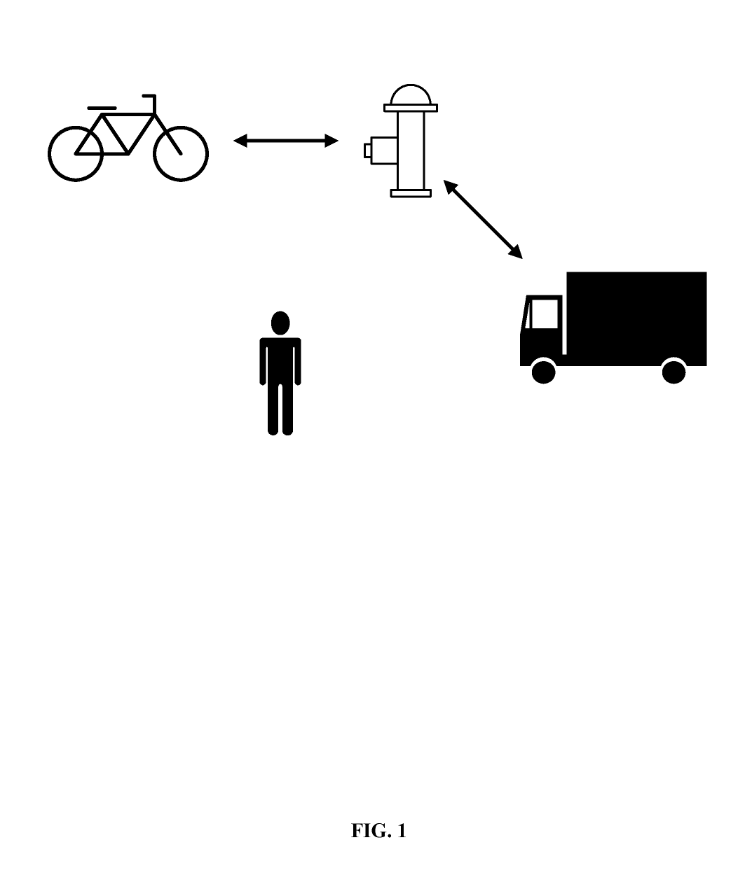

FIG. 2 shows an example of an avatar viewing objects based on egocentric transformation.

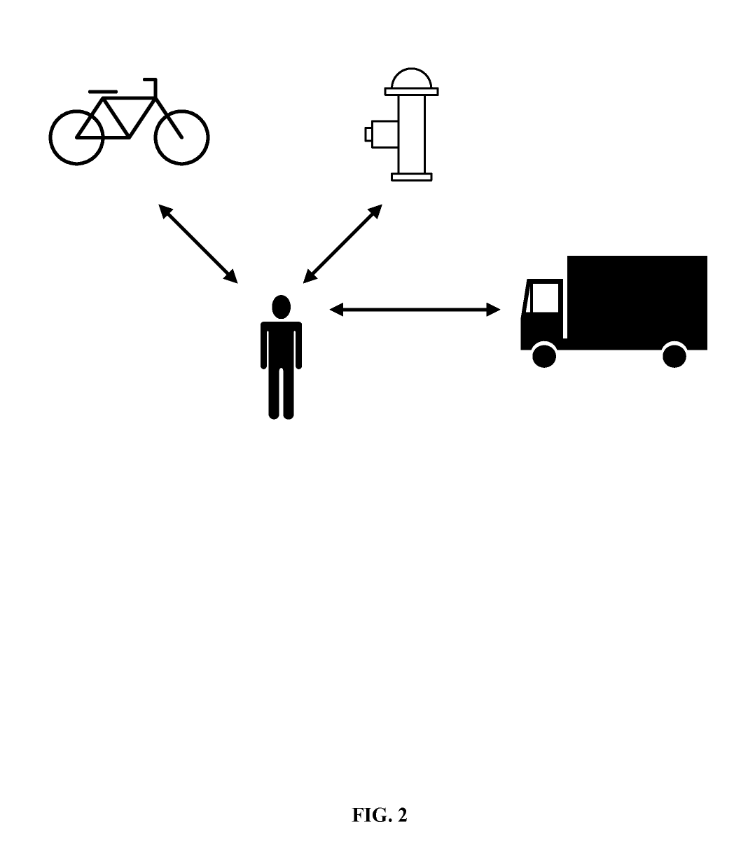

FIG. 3 shows an example of a block diagram for measuring PTA.

FIG. 4 shows an example of a flow diagram for measuring PTA.

FIG. 5 shows an example of a physical/tangible computer readable medium embedded with PTA measurement instructions that are executable and to be applied in a 3D PTA system.

FIG. 6 shows a chart illustrating pointing accuracy as a function of imagined heading and PTA test version as one exemplified aspect of the present invention.

FIG. 7 shows a chart illustrating latency (reaction time in seconds) as a function of imagined heading and PTA test version as one exemplified aspect of the present invention.

FIG. 8 shows a chart illustrating latency (reaction time in seconds) as a function of pointing direction and PTA test version as one exemplified aspect of the present invention.

FIG. 9 shows a chart illustrating pointing accuracy as a function of pointing direction and PTA test version as one exemplified aspect of the present invention.

FIG. 10 shows a chart illustrating pointing accuracy as a function of pointing direction (front/back) and PTA test version as one exemplified aspect of the present invention.

FIG. 11 shows a chart illustrating latency as a function of pointing direction (front/back) and PTA test version as one exemplified aspect of the present invention.

FIG. 12 shows a chart exemplifying mean number of errors as a function of error type and PTA test version.

FIG. 13 shows a chart exemplifying mean number of reflection errors as a function of pointing direction (front/back) and PTA test version.

FIG. 14 shows a chart exemplifying mean number of errors as a function of pointing direction (front/back) and PTA test version.

FIG. 15 shows a chart exemplifying mean number of adjacent errors as a function of pointing direction (front/back) and PTA test version.

FIG. 16 shows trends (regression lines) for the accuracy change as a function of practice for PTA test versions as one exemplified aspect of the present invention.

### DETAILED DESCRIPTION OF THE INVENTION

The present invention embodies a 3D PTA tool that assesses a person's spatial orientation and spatial navigation abilities. Usable as a precursor for navigational training (e.g., aeronautical training, flight training, etc.), the 3D PTA tool helps determine whether such person is capable of such training.

As an assessment testing system, the 3D PTA tool comprises of a multitude of software and hardware elements. With respect to the software component, any available VR software can be used and customized. For example, the present invention may incorporate Vizard 3.0, by WorldViz LLC of Santa Barbara, Calif.; EON 6.0, by EON Reality, Inc. of Irvine, Calif.; Mindreader Virtual Reality Explorer Kit by Themekit Systems, Ltd. of Leicester, United Kingdom; etc. Customization allows the present invention to incorporate certain testing instructions (e.g., creating a specific angle between a starting object and a target object for testing the test subject; introducing a delay condition (such as 5 seconds); etc.) or environments (e.g., creating avatars and objects).

Whichever software is incorporated, it may be stored in the form of a physical or tangible computer readable medium (e.g., computer program product, etc.), where test trials run on a 3D VR computer system and where the images are generated, recorded, and displayed on the same 3D VR computer system.

Examples of the physical or tangible computer readable medium include, but are not limited to, a compact disc (cd), digital versatile disc (dvd), blu ray disc, usb flash drive, floppy disk, random access memory (RAM), read-only memory (ROM), erasable programmable read-only memory (EPROM), optical fiber, electronic notepad or notebook, etc. It should be noted that the physical or tangible computer readable medium may even be paper or other suitable medium in which the instructions can be electronically captured, such as optical scanning. Where optical scanning occurs, the instructions may be compiled, interpreted, or otherwise processed in a suitable manner, if necessary, and then stored in computer memory.

To execute the software's instructions, any 3D VR computer system or processor/apparatus (for example, Precision Position Tracking System, by WorldViz LLC of Santa Barbara, Calif.) or “other device” that is configured or configurable to execute embedded instructions can be used. “Other device” may include, but is not limited to, head-mounted device (HMD), immersive cave projection system, shutter glass, haptic device, navigation device, hard drive, cd player/drive, dvd player/drive, cell phone, personal digital assistant (PDA), etc. that can be connected to a hardware running and/or displaying a 3D VR setting. Connectivity includes wired, wireless, and remote connections.

Overall, the 3D PTA tool involves testing test subjects under a number of trials in a virtual reality (VR) setting. The VR setting portrays a scene with a three-dimensional, spatially laid out array of objects. For each trial, the test subjects are asked to mentally re-orient themselves by imagining themselves as an avatar that is looking at a starting object from the perspective of the avatar. After a delay, the test subjects are then asked to point in the direction of a target object from this perspective. Thereafter, their accuracy and response time are measured.

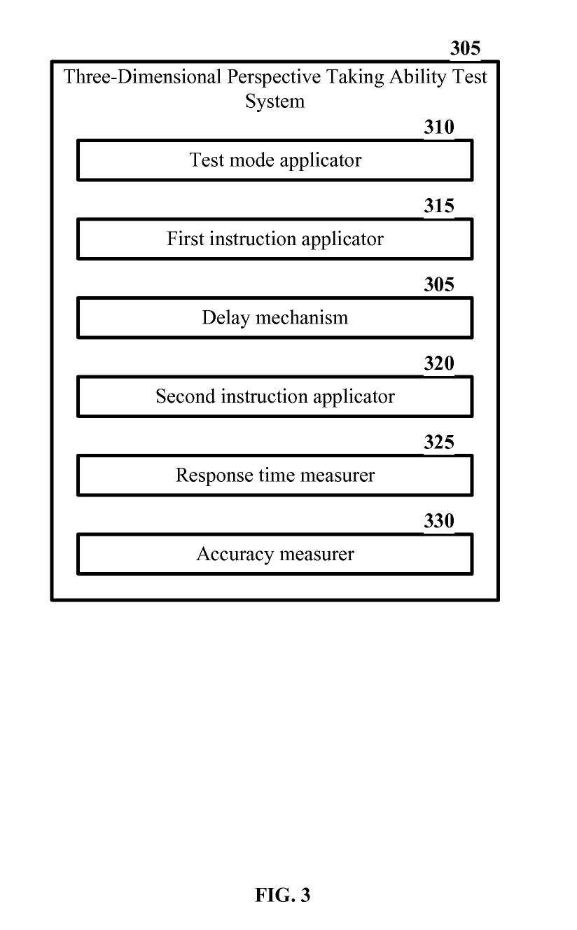

More specifically, as illustrated in FIG. 3, upon execution of the VR software component, one or more processors of the 3D PTA tool activates a test mode applicator. The test mode applicator may be used to run a test mode that applies a 3D VR setting and measures spatial orientation and spatial navigation abilities of a test subject. The test mode encompasses a number of test trials where each trial comprises two sets of instructions for each test subject to follow. Once the test is initiated, a first instruction applicator introduces a first set of instructions. The first set of instructions includes instructing a test subject to mentally re-orient (or reposition) oneself within the VR setting. Mental re-orientation means imagining oneself as an avatar (or some other object) that is seen in the VR setting and looking at a starting object from the avatar's (or some other object's) point of view. For example, the first set of instructions may instruct the test subject to: “Imagine you are the person seen in the VR setting and that you are facing a bench. Point at the bench with the pointing device.”.

As an embodiment, the first set of instructions may also include instructing the test subject to point an input device in the direction of the starting object from the avatar's (or some other object's) perspective. The input device is a tracking marker that can track its orientation. Nonlimiting examples of input devices include a gyromouse (like Air Mouse by Gyration of Movea, Inc., Milpitas, Calif.), remote control, etc. The input device can have at least one button for the test subject to press that enables the recording of the test subject's responses (namely, a pointing direction and a response time).

The 3D PTA tool may also include a delay mechanism. This delay mechanism may be embedded in the first instruction applicator. Such module creates a delay condition or pause in the test mode after execution of the first set of instructions to allow the test subject to mentally re-orient himself. The delay condition can be customized and set by a test administrator. The delay time can be a standard (e.g., 5 seconds), random, and/or randomized oscillating (e.g., 7, 1.5, or 23 seconds) time delay.

Optionally, the test mode can be set to have no delay condition (or 0 seconds). However, if a delay is to occur, the pause must come after the first instruction applicator executes the first set of instructions but before the second instruction applicator executes the second set of instructions.

Where the test mode applies the delay condition, a second instruction applicator in the 3D PTA tool introduces a second set of instructions after the pause. The second set of instructions may, for example, demand the test subject to perform the following instructions: “Now, point to the Bicycle and click the mouse.” This second set dictates the test subject to point in the direction of a target object while looking at the starting object from the perspective of the avatar. Using the input device, the test subject is to point the input device in the direction of the target object. In each trial, whenever and wherever the test subject points the input device, the pointing direction (and the time it takes for the test subject to point) is recorded.

There are a number of ways the present invention registers the test subject's response (namely, pointing direction, movement, and/or selection). For instance, the input device may have at least one designated button for the test subject to press. After the test subject presses such button, an accuracy measurer of the 3D PTA tool records the test subject's response (e.g., pointing direction).

Simultaneously, response time measurer of the 3D PTA tool measures the time it took for the test subject to respond after being provided the second set of instructions. It is within the scope of the present invention that the response time measurer can also track and record each movement (position and orientation) of the input device. To accomplish this feature, the input device may have an internal tracking mechanism where any movement of the input device is automatically recorded after the input device is first recognized by the response time measurer.

As the response and the response time are recorded, the accuracy of each response may also be determined by using the 3D PTA tool's accuracy measurer. Accuracy refers to how close the test subject's responses (the angle created by the test subject's response) are to the actual angle that is formed between the starting object and target object of each trial. The accuracy measurer may also compute the test subject's 3D PTA test score for each trial, multiple trials (selected or nonselected), or all the trials.

Another embodied way to track movement of the input device may be connecting (via wires, wirelessly, or remotely) at least two tracking mechanisms to the 3D PTA tool. These tracking mechanisms (such as tracker devices, cameras, etc.) can track the position of each response and may be strategically placed in the environment housing the 3D PTA tool as a separate component. For instance, they may be placed in a corner of the ceiling or floor. It should be noted that while using two tracking mechanisms is sufficient for tracking position, using more than two tracking mechanisms is better for tracking each response.

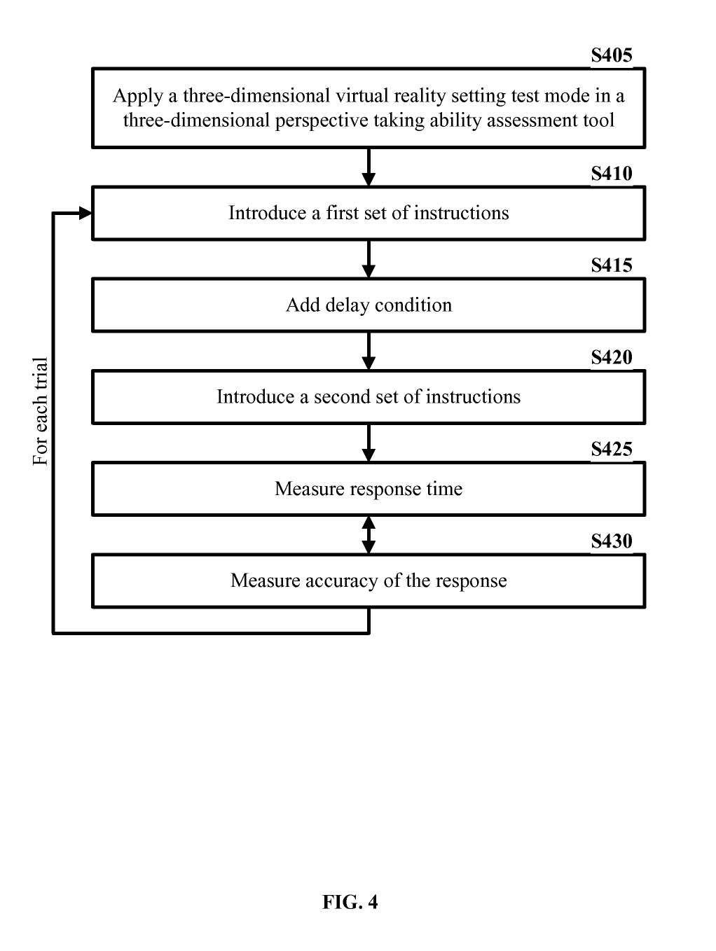

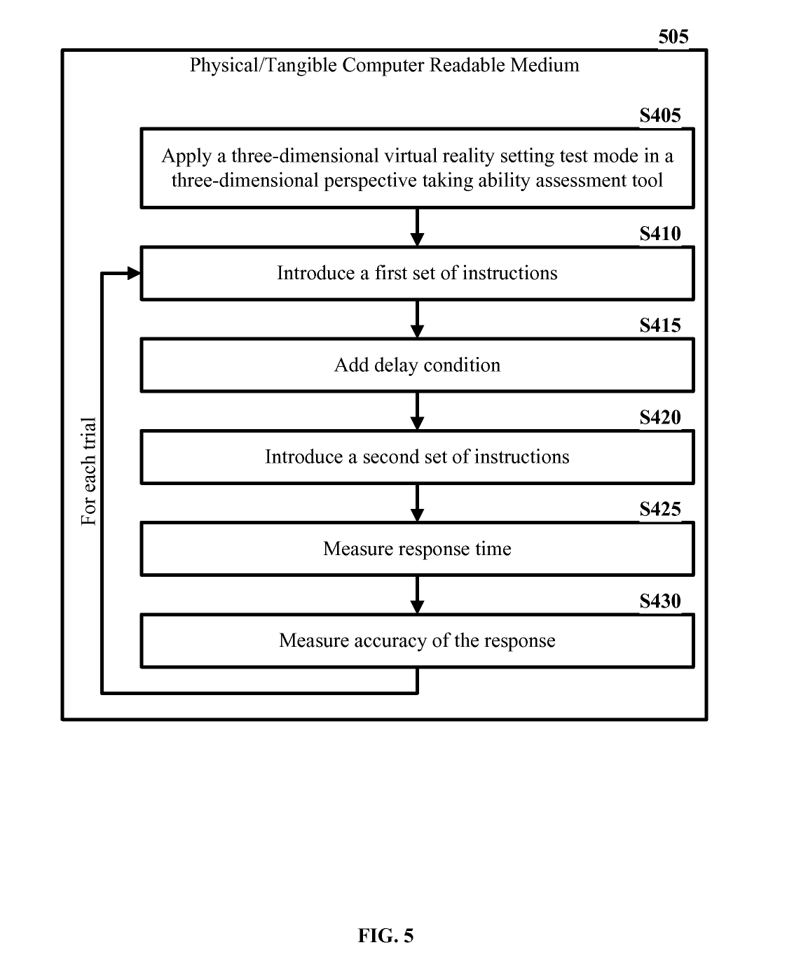

All of the embodied operations of these hardware components may be separately and independently embodied as spatial orientation and spatial navigation assessment methods (such as in FIG. 4). Each of such methods can be embodied (such as in FIG. 5) in a physical or tangible computer readable medium and executable in any 3D PTA system, apparatus, or application. Results generated from these methods can be graphically generated, transformed, and displayed in the 3D PTA system or apparatus.

Referring to FIG. 4, the spatial orientation and spatial navigation assessment methods include using a PTA assessment tool to apply a test mode in a 3D VR setting, where for each trial in the test mode, introducing a first set of instructions that instructs a test subject to mentally re-orient himself in the 3D virtual reality setting from the perspective of an avatar (or some other object) that is facing a staring object; adding a delay condition after the first set of instructions to allow the time for test subject to mentally re-orient himself; introducing a second set of instructions after the delay condition expires that dictates the test subject to point an input device (e.g., a gyromouse, remote control, etc.) in the direction of a target object based on the view of the avatar (or some other object); tracking the test subject's response to the second set of instructions; measuring the test subject's response time after the second set of instructions are provided; and measuring the accuracy of the test subject's response. As an embodiment, it should be noted that the response needs to be recorded to calculate the accuracy of the response.

3D VR Systems—Immersive V. Non-Immersive

The 3D PTA tool may be performed in two different kinds of 3D VR systems. One kind of system is an immersive VR system. Another kind is a non-immmersive VR system (which is sometimes referred to as a remote 3D VR system, desktop 3D VR system, or laptop 3D VR system).

Various immersive VR systems may be incorporated, and the present invention is not limited to the exemplified embodiments herein. For instance, the immersive VR system may be equipped with a stereoscopic head mounted display (such as the Virtual Research VR HMD 8 by Virtual Research Systems of Aptos, Calif.), at least two tracking mechanisms, and an input device. The tracking mechanism may be a portable position and orientation tracker (e.g., PPT X2, two-camera track system by WorldViz of Santa Barbara, Calif.). The input device (which, in one example, may be referred to herein as “magic wand”) may be used for easy pointing and interaction, whereupon the pointing direction is recorded for each trial.

Similarly, various non-immersive VR systems may also be incorporated, and the present invention is not bound to only the exemplified embodiments herein. The remote 3D VR system may be equipped with active stereoscopic glasses for 3D viewing and a controller for responses. Various types of controllers (e.g., joystick, mouse, gyromouse, game controllers, magic wand, etc.) may be used.

Each of these 3D VR systems may involve the use of one or more desktop computers, laptops, servers/clients or equivalent devices that can run the physical or tangible computer readable medium. Data may be transmitted through wired communication lines, wirelessly or remotely. One skilled in the art may come to know and appreciate various types of wireless communication that can be used, such as Bluetooth or Bluetooth-like capabilities, 802.11 a/b/g, infrared, routers, multimedia message format, etc.

Immersive virtual reality provides the best synthetic environment for the illusion of presence. Quite often, an immersive VR system utilizes special hardware that provides high levels of graphics and performance.

As for its counterpart, a non-immersive desktop VR system is an implementation of VR techniques, where the virtual environment is viewed through a window by utilizing a standard high resolution monitor. Such system does not require the highest level of graphics, performance, and special hardware, and thus is low cost and widely accessible. However, a non-immersive VR system is of little use where the immersion is an important factor.

Embodied Features

The 3D PTA tool has several unique features that discriminate it qualitatively from all other existing tests. These features include, but are not limited to, the immersion and 3D stereoscopic view. Naturally, test subjects are accustomed to orientation/navigation in 3D physical spaces/real environments. By using the immersion and 3D stereoscopic view, test subjects' perceptual illusion (sense of presence in the VR setting) greatly improves.

Another embodied feature involves systematic selection of re-orientation angles. Where the re-orientation angle (relative to a normal view) is less than 100 degrees, test subjects often apply mental strategies (e.g., mental rotation strategy) other than a perspective taking strategy to solve spatial tasks. This trend is also seen where the re-orientation angle is a canonic angle (e.g., 0, 90, 180 or 270 degrees). To avoid this problem, the re-orientation angle in each of the trials of the 3D PTA tool may be manipulated and carefully selected to be equal to or greater than 100 degrees and to exclude canonic angles. For instance, the re-orientation angles may be 153 degrees, 136 degrees, 298 degrees, etc.

The difference between perspective taking strategy and mental rotation strategy is that the former is a two-step process, whereas the latter is a one-step process. The two-step process generally involves re-orienting oneself within the VR setting and then pointing in the direction of a target object from this re-oriented view. The one-step process generally involves mentally rotating the VR array of objects as a whole. Moreover, whereas the perspective taking strategy correlates highly with spatial orientation and spatial navigation abilities, the mental rotation strategy is a different ability not related to navigational skills.

Conventional test settings do not provide sufficient data as to which test subjects are using the perspective taking strategy and which test subjects are using the mental rotation strategy. Experimental results show that when test subjects are provided with full instructions at the beginning of the test, response times were very similar for those who applied the perspective taking strategy and for those who applied the mental rotation strategy. Response times ranged from ˜5 to ˜8 seconds.

To identify which strategy each test subject is using, a delay condition is introduced as another embodiment. As explained above, the instructions for each trial in the 3D PTA test are given in two steps and separated by a certain delay (for example, about 5 seconds). For instance, a test administrator may give the test subjects the following exemplified first set of instructions: “Imagine you are the person. You are facing the Bench.” After delaying (waiting) for a bit (such as about 5 seconds), the test administrator would then give the test subjects a second set of the instructions, such as “Now point to the Bicycle.”

When only the first set of instructions is given (e.g., “Imagine you are the person. You are facing the Bench”), followed by a delay, test subjects using the perspective taking strategy are able to perform the first set of instructions and re-orient themselves with respect to the array.

However, test subjects using the mental rotation strategy generally cannot function the same way. Often, they are unable to perform the first set of instructions like their counterparts using the perspective taking strategy because they require the full set of instructions (first and second set of instructions) before they can mentally rotate the array (the whole vector). In essence, having the complete set of instructions is how the mind works for those using the mental rotation strategy.

By implementing the delay condition and measuring the response time subsequent to the second set of instructions (i.e., the pointing direction instructions), it is possible to differentiate successfully between two strategies. While the response time of test subjects who used the mental rotation strategy remain the same (˜5 to ˜8 seconds), the response time of those who used the perspective taking strategy drops dramatically (from ˜5 to ˜8 seconds to ˜2 to ˜3 seconds). Thus, the incorporated delay condition provides a unique way, otherwise inaccessible, to differentiate between perspective taking and mental rotation strategies and to filter out test subjects applying the mental rotation strategy from the pool using the perspective taking strategy.

In addition to the above features, the scoring algorithm is also another unique feature of the 3D PTA test. The itemized scoring can be given by the following formula:

$$\frac{100}{( RT + 2 ) \times ( 1 + {( \frac{Δ α}{22.5} )}^{2} )} \qquad ( 1 )$$

where RT is the reaction time (in seconds) and Δα (the accuracy of the responses) is the angle difference between the correct response key and the subject's response (in degrees, from 0 to 180 degrees in 45 degrees increments).

The scoring algorithm takes into account both accuracy and response time. Special attention may be taken to differentiate between people who use the perspective taking strategy and those who don't. Scoring also takes into account correction for guessing.

Scores may be measured by the length of time it takes for test subjects to response. It may also include how accurate those responses are. Generally, scores may range from 0 to 50. A high score may be categorized from about 25 or higher. High scorers will most likely be perspective taking strategists. An average score may be categorized from about 15 to about 25. Average scorers are likely to be average perspective taking strategists. A low score may be categorized from 0 to about 15. Low scorers will most likely be low perspective taking strategists. High scores reflect those who have good spatial orientation and spatial navigation abilities. On the contrary, low scores reflect those who have poor spatial orientation and spatial navigation abilities.

It should be noted that a more general formula can be used. For instance, the formula may take into account only the RT. However, such general formula would not be as accurate in measuring PTA as the one above, which also takes accuracy into consideration. Hence, if the formula used takes into account test subjects' reaction time and accuracy, the score will better reflect the test subjects' PTA.

It should also be noted that test subjects who use mental rotation strategy may or may not have the ability the use perspective taking strategy as well. In other words, those who score high using mental rotation strategy may reflect either a low or high score on the 3D PTA test. Similarly, those who use perspective taking strategy may or may not have the ability to use mental rotation strategy as well. Nevertheless, whether test subjects can apply one or both strategies, the determining factors are the accuracy and response time after the delay condition. The more accurate the response and the shorter the response time generally reflect those who are using perspective taking strategy.

Exemplified Testing and Results

Experiments may be conducted with any sample size of test subjects. The number of trials conducted should be near or at least 56 stimuli trials, which equate to a standardized psychological test. In one experiment, 27 students were tested. Results from this experiment showed a high internal reliability of 0.97 (Cronbach alpha) and validity.

Previously, findings show that the ability to perform egocentric perspective-taking transformations predicts navigation abilities that require updating self-to-object representations. It is an established finding in cognitive psychology research that when the egocentric system is involved, back directions are harder than front directions. Furthermore, when allocentric system (object-based transformations) is involved, there appears to be no difference in difficulties between back/front and right/left discriminations. Compared with a 2D PTA (map format), the 3D PTA tool is characterized by significantly more back (relative to the front) errors in pointing direction, as one would expect if the egocentric system would be involved.

However, findings from the 3D PTA tool generally show a discriminative pattern of responses. In particular, the analysis of the responses showed that 3D PTA has significantly more “reflection” errors than 2D PTA, where subjects confused between back with front as well as between left and right responses. In contrast, 2D PTA has more “adjacent” errors, which occur when test subjects use mental rotation strategy and mentally “under-rotate” or “over-rotate.” This pattern of responses is indicative that the 3D PTA test is more strongly loaded on the egocentric system, and thus, can be considered as a unique measure of spatial orientation and spatial navigation abilities.

Moreover, it was experimentally verified that the 3D PTA test has a significantly stronger training effect than 2D PTA (map format). Thus, the 3D PTA test serves as a unique tool for improving navigation task performances by effective use of a virtual environment to organize navigable 3D tasks and transfer training to real-world tasks.

Descriptive Statistics

Table 1 represents descriptive statistics for the three versions of the PTA test (i.e., 3D immersive, 3D non-immersive, and 2D), where 13 test subjects were tested.

TABLE 1
Descriptive statistics for 3 versions of the PTA test

| | | Mean | | Mean | |
|---|---|---|---|---|---|
| Test | N | accuracy | SD | RT (s) | SD |
| 3D | 13 | 27.03 | 7.19 | 4.46 | 1.70 |
| immersive | | | | | |
| 3D non- | 13 | 23.35 | 6.05 | 3.75 | 1.15 |
| immersive | | | | | |
| 2D | 13 | 24.80 | 8.07 | 3.84 | 1.50 |

Pointing Accuracy and Latency as Functions of the Imagined Heading

A change in perspective is a process that can be divided into two steps: (1) imagining the new facing direction (e.g., mentally rotating oneself) and (2) pointing to the target from that newly imagined facing direction.

Imagined heading is defined as the angle between the participant's actual perspective and the figure's perspective. Pointing accuracy (i.e., absolute angular error) and latency (reaction time for correct trials in seconds) can vary as functions of imagined heading (e.g., 100°, 120°, 140°, and)160° and version of the PTA test (i.e., 3D immersive, 3D non-immersive, and 2D). Data can be analyzed using a 4×3 repeated measures ANOVA with General Linear Model (GLM) in SPSS.

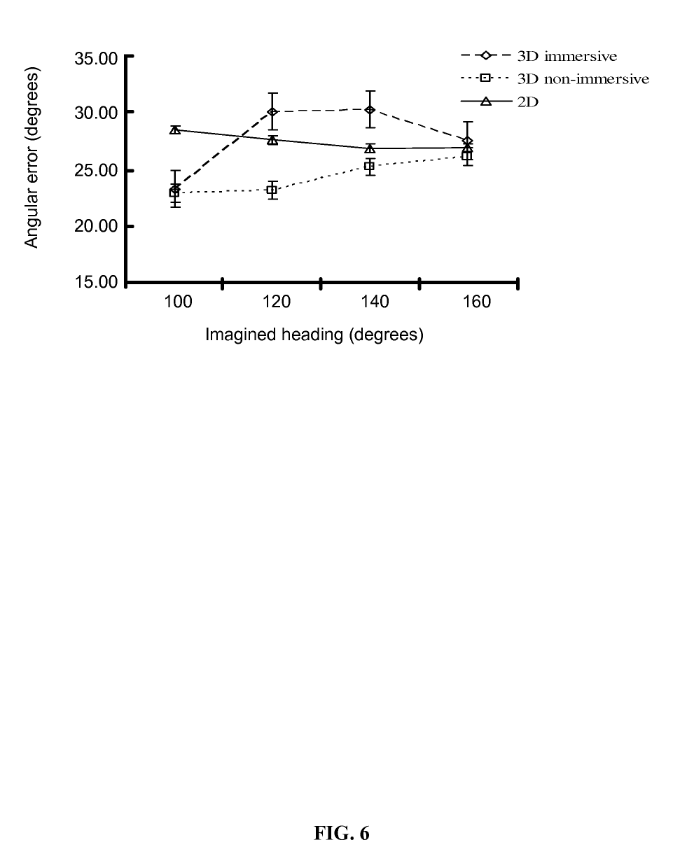

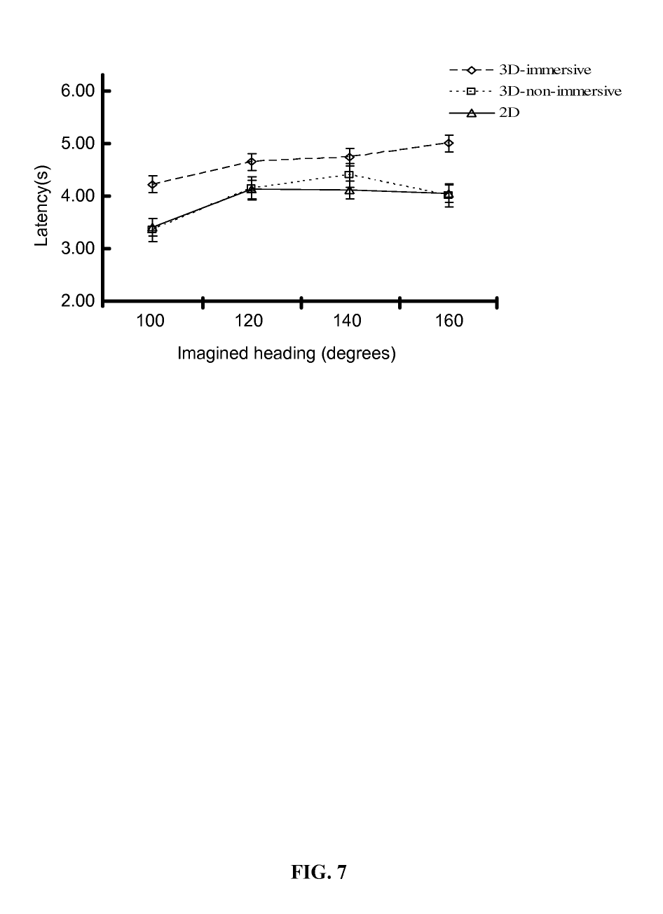

Referring to the figures, FIG. 6 shows pointing accuracy as a function of imagined heading and PTA test version. FIG. 7 shows latency (reaction in time in seconds) as a function of imagined heading and PTA test version. Means and standard errors are displayed for both figures, where error bars represent standard error means. It should be noted that, for both figures, the y-axis does not begin at the origin.

Although the effects of imagined heading and test version were not significant for pointing accuracy (where p=0.51 for imagined heading and p=0.255 for test), there were significant main effects for latency (where f(3,36)=7.23, p<0.01 for imagined heading and f(2,24)=5.43, p<0.05 for test). As seen in FIG. 7, reaction times for 100° were significantly faster than reaction times for 140° (p=0.008). Moreover, reaction times for 3D immersive were significantly slower than reaction times for 2D (p=0.03).

Performance on the new 3D immersive PTA test, as reflected in FIG. 6 was consistent with experimental research, where absolute angular error generally increased with the angular deviation of a participant's actual perspective from that of the figure's perspective. Similarly, as seen in FIG. 7, latency increased with angular deviations. In general, the 3D PTA task appears to be more difficult in a 3D immersive environment as shown by longer latencies and higher angular error. It should be noted that for both these figures, error bars represent standard error means, and the y-axis does not begin at the origin.

Pointing Accuracy and Latency as Functions of Pointing Direction

Pointing direction is defined as the actual direction of the target from the imagined heading. Pointing accuracy and latency were examined as a function of pointing direction (front right—FR; front left—FL; back right—BR; and back left—BL) and test version using a 4×3 repeated measures design with GLM in SPSS.

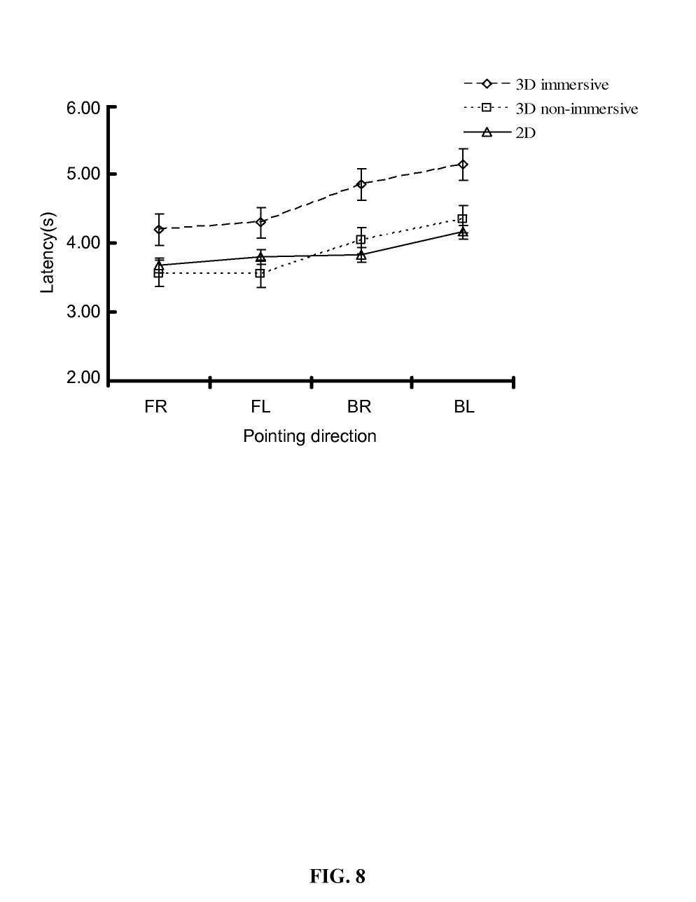

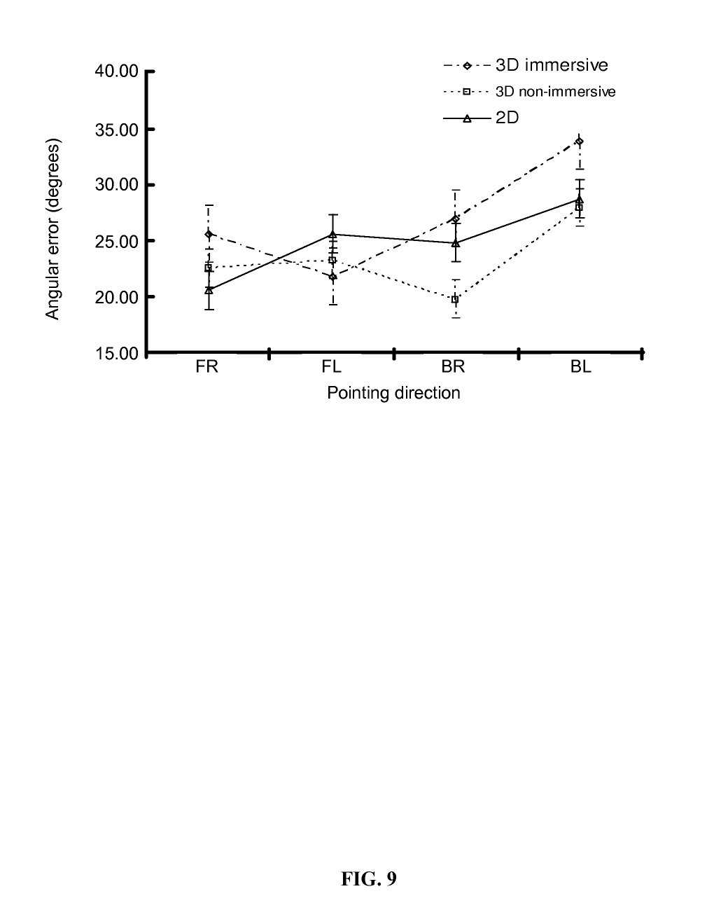

Referring to the figures, FIG. 8 shows latency (reaction time in seconds) as a function of pointing direction and PTA test version. FIG. 9 shows pointing accuracy as a function of pointing direction and PTA test version. Means and standard errors are displayed for both figures, where error bars represent standard error means. It should be noted that, for both figures, the y-axis does not begin at the origin.

In this example, there were significant main effects of pointing direction for both pointing accuracy and latency: f(3,36)=8.67, p<0.001 and f(3,33)=9.43, p<0.001 respectively. Responses were significantly less accurate (p=0.001) and slower (p=0.025) for BL compared to FR for all three tests. Responses were also significantly slower for BL compared to BR (p=0.032). The effect of test version was significant for latency [f(2,22)=5.71, p<0.05] and marginally significant for pointing accuracy (p=0.15). Mean reaction times were significantly slower for 3D immersive than 2D (p=0.01). While the interaction between pointing direction and test version was not significant for latency (p=0.32), it was marginally significant for pointing accuracy (p=0.15).

Based on these results, it appears that participants were generally less accurate and slower for back pointing directions compared to front pointing directions.

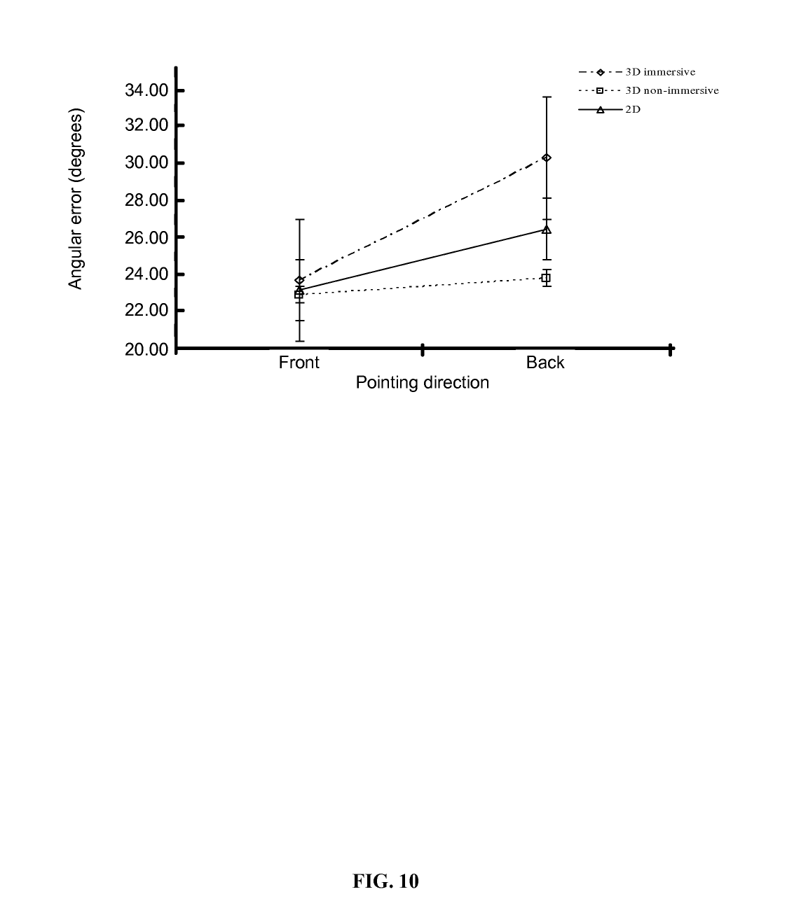

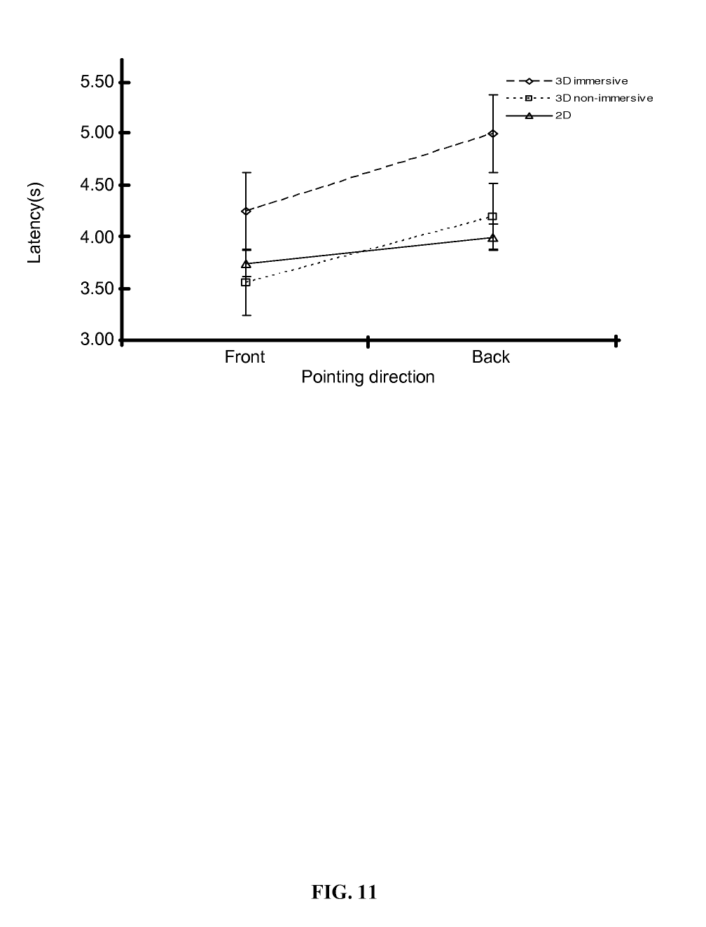

These results are consistent with previous findings by Kozhevnikov. Furthermore, the results were further examined by collapsing left and right pointing directions into front and back categories (as seen in FIG. 10 and FIG. 11. There were significant main effects of front/back pointing directions for both pointing accuracy and latency where responses were less accurate and slower for back pointing directions than front pointing directions: f(1,12)=11.94, p<0.01 and f(1,11)=14.84, p<0.01 respectively. The results for test version were the same as above.

Referring to the figures, FIG. 10 shows pointing accuracy as a function of pointing direction (front/back) and PTA test version. FIG. 11 shows latency as a function of pointing direction (front/back) and PTA test version. Like above, Means and standard errors are displayed for both figures, where error bars represent standard error means. Also, for both figures, it should be noted that the y-axis does not begin at the origin.

The interaction between back/front pointing direction and test version was marginally significant for latency: f(2,22)=3.15, p=0.06. Examination of the simple main effects revealed that back responses were significantly slower than front responses for both 3D immersive (p=0.002) and 3D non-immersive (p=0.013) test versions but that back and front latencies were similar in 2D (p=0.13).

The pattern of findings for pointing direction in 3D immersive is consistent with previous evidence that back pointing directions tend to be more difficult than front pointing directions. This result is due to the use of egocentric perspective transformations, during which people often make more mistakes in back pointing direction trials than in front pointing direction trials. Furthermore, the finding that angular error was larger in back pointing directions versus front pointing directions in the 3D immersive test version suggests that these egocentric perspective transformations are used more often in the virtual reality than in the 3D non-immersive or 2D environments. If the prediction that egocentric transformations are used more often in back pointing directions than front pointing directions, and particularly in virtual reality, is true, then there should be more reflection errors in these conditions. This hypothesis was tested in the following analyses.

Comparison of Error Types

Different types of errors were examined to infer the types of strategies used. Reflection errors were defined as those which reflect the symmetry of the coordinate system of the body or difficulties in specifying right-left and back-front directions to the target. Reflection errors included those that were within 25° of a response that was a reflection of the correct response through the horizontal, vertical, or both axes. These types of errors generally reflect egocentric spatial transformations.

Adjacent errors were defined as those which reflect mental rotation transformation errors reflecting the under-rotation or over-rotation of the imagined self or target object. Adjacent errors included those were greater than 25° of a response but not reflected through the horizontal or vertical axes. These types of errors typically reflect object-based rather than egocentric-based spatial transformations.

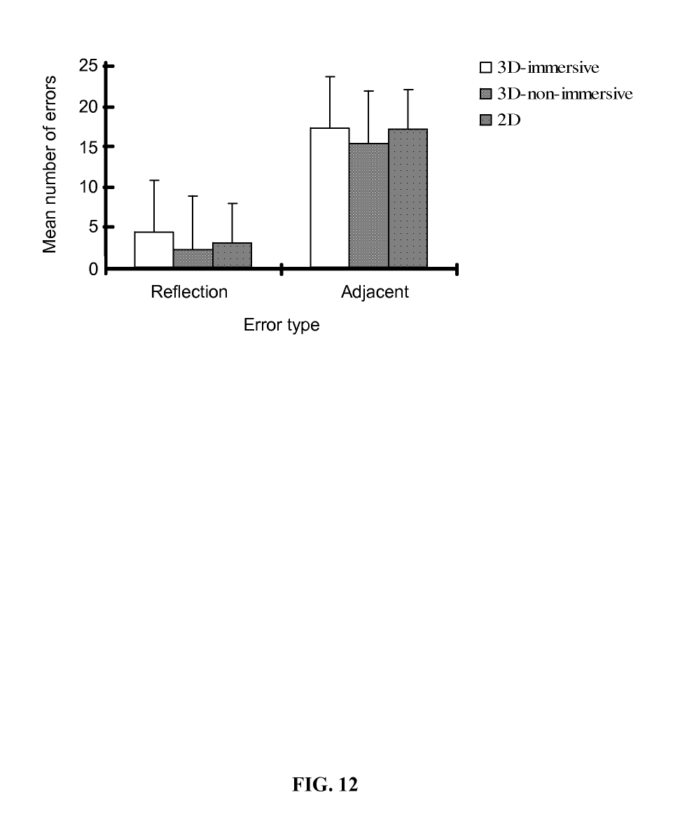

The mean number of errors was examined as a function of test version and error type (adjacent versus reflection) using a 3×2 repeated measures ANOVA with GLM in SPSS and the results are displayed in FIG. 12. For all test versions, there was a significant main effect of error type [f(1,12)=187.19, p<0.001] where more adjacent than reflection errors were committed. The effect of test approached significance (p=0.16). The interaction was not significant (p=0.85).

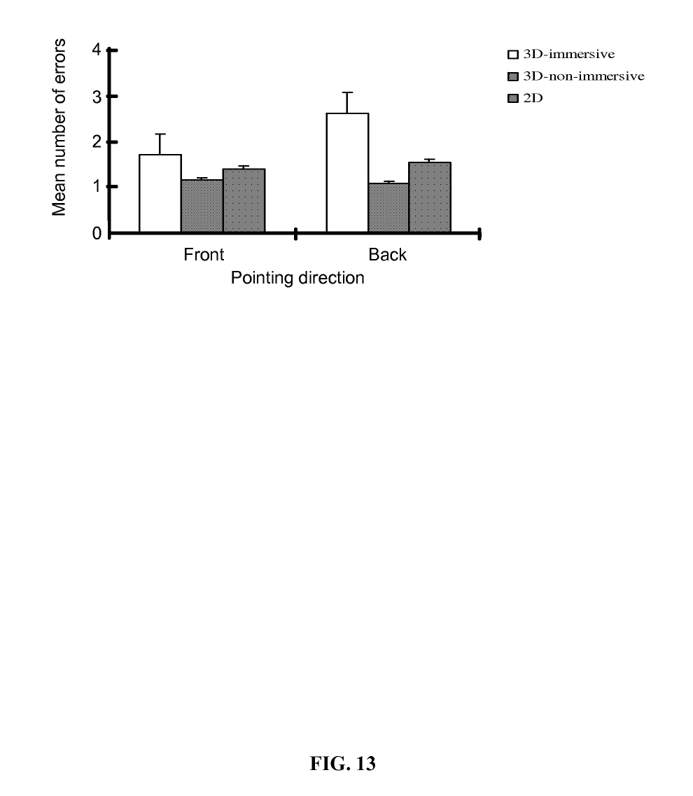

To test the hypothesis that an egocentric frame of reference was used in back pointing directions and in the 3D-immersive environment, the number of reflection errors in each condition was compared and the results are presented in FIG. 13. A 2 (front vs back)×3 (test version) repeated measures ANOVA with GLM was conducted using SPSS. This analysis revealed a marginally significant main effect of test version: f(2,24)=2.95; p=0.071. The effect of back/front pointing direction was not significant (p=0.54). Participants committed significantly more reflection errors on the 3D immersive version of the PTA test compared to the 3D non-immersive version and 2D version: f(1,12)=9.41, p=0.01.

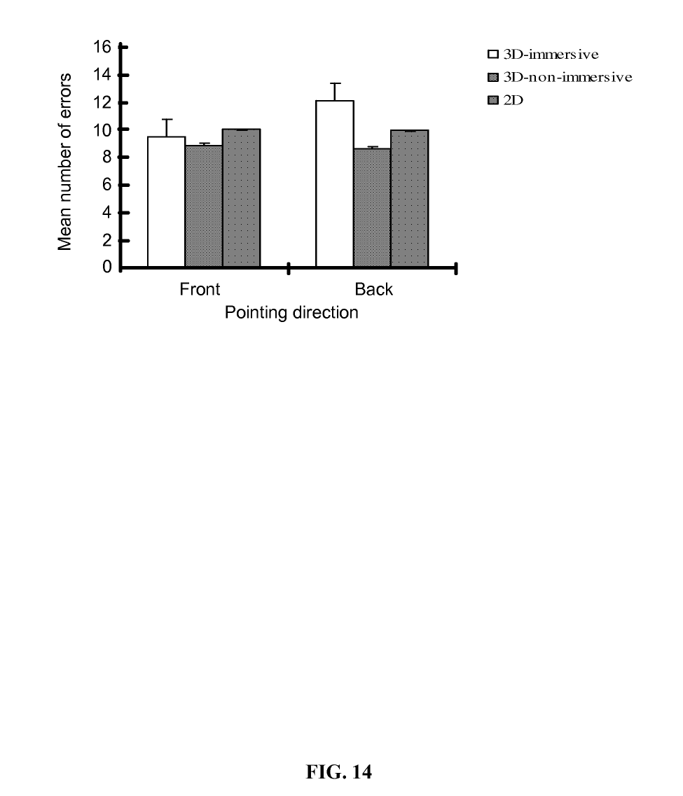

FIG. 14 shows a mean number of errors as a function of pointing direction (front/back) and PTA test version.

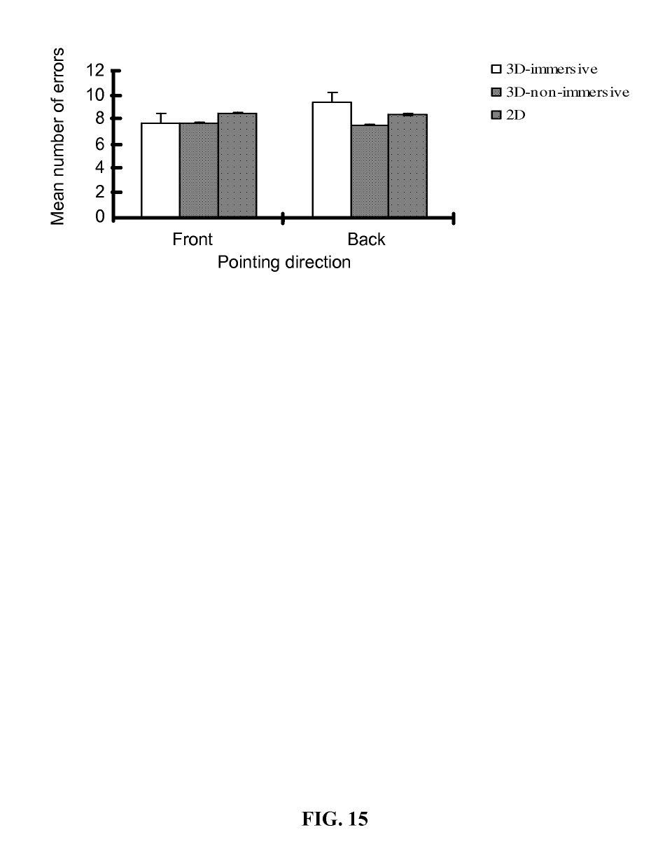

Furthermore, as illustrated in FIG. 15, no more adjacent errors were committed in the back versus the front (p=0.63) or in the 3D immersive versus other PTA test conditions (p=0.57). In summary, the finding that participants committed more reflection errors for back pointing directions in the 3D immersive environment suggests that an egocentric frame of reference is used in this condition.

Training Effect

The 3D PTA tool with the delay condition assesses PTA, and thus, is a valid measure of spatial orientation and spatial navigation abilities. It can be used by employers to screen job candidates for certain professions that require navigational abilities. For example, it can be used to screen out astronauts, pilots, drivers, etc. Furthermore, the 3D PTA tool is a unique tool that can be used to improve navigation task performances. Specifically, this test can train people with real-world tasks by effectively using a virtual environment to organize navigable 3D tasks.

The analysis of a trend (linear regression) for the angular error change during exemplified test sessions shows the significant difference between 3D and 2D. This trend reflects the training capability of a subject: as the slope of the trend increases, the faster a subject improves the accuracy while pointing objects during the test. The slope is the vertical distance divided by the horizontal distance between any two points on the line, which is the rate of change along the regression line.

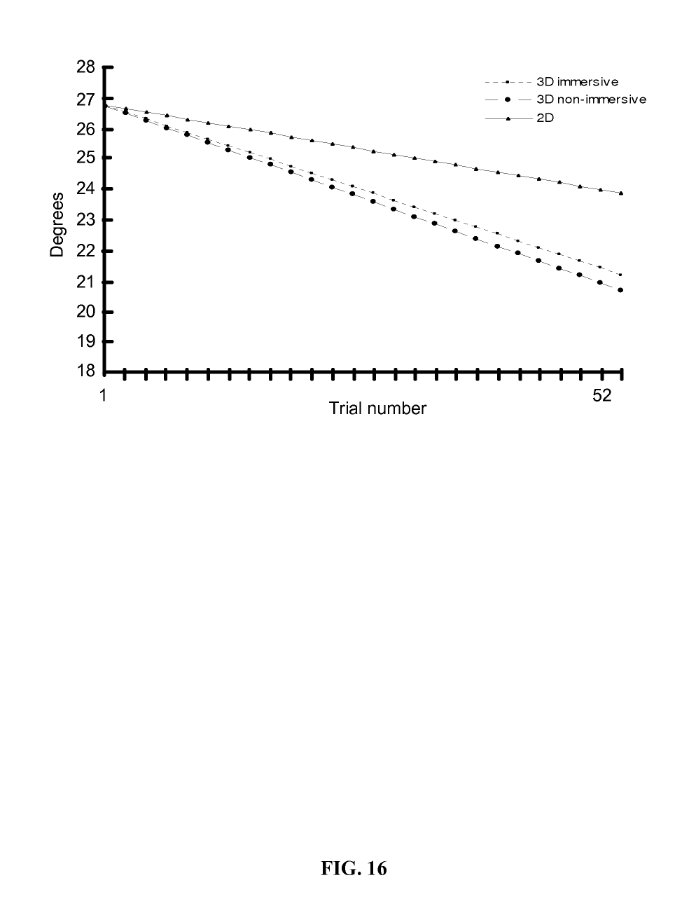

As illustrated, FIG. 16 shows average angular error trends (for 15 subjects) (e.g., regression lines for PTA test versions), the speed of training process is highest for 3D non-immersive test (slope −0.24). The speed of training process is a bit lower for 3D immersive test (slope −0.22), which appears to be caused by an unusual character of virtual reality environment. As for 2D, the speed of training process is twice smaller (slope −0.12). Thus, the 3D tests have an obvious advantage over the 2D test and may serve as an effective training instrument for the development of spatial navigation abilities.

### REFERENCES

D. Bryant & B. Tversky, Mental Representations of Perspective and Spatial Relations from Diagrams and Models, 25 J. Experimental Psychol. (1999).
R. D. Easton & M. J. Sholl, Object-array Structure, Frames of References, and Retrieval of Spatial Knowledge, 21 J Experimental Psychol. 483-500 (1995).
D. L. Hintzman et al., Orientation in Cognitive Maps, 13 Cognitive Psychol. 149-206 (1981).
M. Kozhevnikov and M. Hegarty, A Dissociation Between Object Manipulation Spatial Ability and Spatial Orientation Ability, 29 Memory & Cognition 745-756 (2001).
M. Maria Kozhevnikov et al., Perspective-taking vs. Mental Rotation Transformations and How They Predict Spatial Navigation Performance, 20 Applied Cognitive Psychol. 397-417 (2006).
R. F. Wang & E. S. Spelke, Updating Egocentric Representations in Human Navigation, 77 Cognition 215-250 (2000).

Many of the elements described in the disclosed embodiments may be implemented as modules. A module (sometimes referred to as element, component, or mechanism) is defined here as an isolatable element that performs a defined function and has a defined interface to other elements. The modules described in this disclosure may be implemented in hardware, software, firmware, wetware (i.e., hardware with a biological element) or a combination thereof, all of which are behaviorally equivalent. For example, modules may be implemented as a software routine written in a computer language (such as C, C++, Fortran, Java, Basic, Matlab or the like) or a modeling/simulation program such as Simulink, Stateflow, GNU Octave, or LabVIEW MathScript. Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL), such as VHSIC hardware description language (VHDL) or Verilog, that configure connections between internal hardware modules with lesser functionality on a programmable device. Finally, it needs to be emphasized that the above mentioned technologies are often used in combination to achieve the result of a functional module.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on the example(s) of embedding a block authentication code in a data stream for authentication purposes. However, one skilled in the art will recognize that embodiments of the invention could be used to embed other types of information in the data blocks such as hidden keys or messages. One of many ways that this could be accomplished is by using a specific hash function that results in a value that either directly or in combination with other data can result in one learning this other type of information.

In addition, it should be understood that any figures which highlight the functionality and advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A three dimensional (3D) perspective taking ability (PTA) test system comprising:
a. a test mode applicator running a test mode that:
i. applies a 3D virtual reality setting; and
ii. measures spatial orientation and spatial navigation abilities of a test subject;
b. a first instruction applicator that gives, for each trial, the test subject a first set of instructions, the first set of instructions instructing the test subject to mentally re-orient himself in the 3D virtual reality setting from the perspective of an avatar that faces a starting object;
c. a delay mechanism that creates a pause in the test mode after the first instruction applicator executes the first set of instructions;
d. a second instruction applicator that gives the test subject a second set of instructions after the pause expires, the second set of instructions instructing the test subject to point an input device in the direction of a target object;
e. a response time measurer that records the test subject's response time after the second instruction applicator provides the second set of instructions; and
f. an accuracy measurer that:
i. records the test subject's response;
ii. calculates the accuracy of the response; and
iii. computes a 3D PTA test score for the trial.

2. The system according to claim 1, wherein the input device is a gyromouse.

3. The system according to claim 1, wherein the input device is a remote control.

4. The system according to claim 1, wherein the response time measurer tracks and records movement of the input device.

5. The system according to claim 1, wherein the system is a 3D immersive virtual reality system.

6. The system according to claim 1, further comprising:
a. a stereoscopic head mount device; and
b. at least two tracking mechanisms.

7. The system according to claim 1, wherein the system is a 3D non-immersive virtual reality system.

8. The system according to claim 7, further comprising:
a. active stereoscopic 3D glasses; and
b. a controller.

9. A spatial orientation and spatial navigation ability test method comprising:
a. using a perspective taking ability assessment tool to apply a test mode in a 3D virtual reality setting; and for each trial,
b. introducing a first set of instructions, the first set of instructions instructing a test subject to mentally re-orient himself in the 3D virtual reality setting from the perspective of an avatar that faces a starting object;
c. adding a delay condition after the first set of instructions;
d. introducing a second set of instructions after the delay condition expires, the second set of instructions instructing the test subject to point an input device in the direction of a target object;
e. tracking the test subject's response to the second set of instructions;
f. measuring the test subject's response time after the second set of instructions are provided; and
g. measuring the accuracy of the test subject's response.

10. The method according to claim 9, wherein the input device is a gyromouse.

11. The method according to claim 9, wherein the input device is a remote control.

12. The method according to claim 9, wherein the method is set in a 3D immersive virtual reality system comprising:
a. a stereoscopic head mount device; and
b. at least two tracking mechanisms.

13. The method according to claim 9, wherein the method is set in a 3D non-immersive virtual reality system comprising:
a. active stereoscopic 3D glasses; and
b. a controller.
